(19) United States
(12) Patent Application Publication
(10) Pub. No.: US 2005/0007039 A1
(43) Pub. Date: Jan. 13, 2005

(54) Display device

(76) Inventors: Frank Anton Van Abeelen, Eindhoven (NL); Michel Cornelis Josephus Marie Vissenberg, Eindhoven (NL)

Correspondence Address: Corporate Patent Counsel;Philips Electronics North America Corporation, P O Box 3001, Briarcliff Manor, NY, 10510, US

(21) Appl. No.: 10/494,826

(22) PCT Filed: Oct. 22, 2002
(86) PCT No.: PCT/IB02/04398

(30) Foreign Application Priority Data
Nov. 12, 2001 (EP) 01204300.6

(51) Int. Cl. H01J 29/70

(52) U.S. Cl. 315/399; 315/397

(57) ABSTRACT

A display device comprises a cathode ray tube (1) with an electron gun (5) for generating at least one electron beam (6) by means of a cathode, a phosphor screen (8) on an inner surface of a display window (2) and a means (9, 27, 28) for deflecting the electron beam(s) across the phosphor screen. The electron gun comprising a pre-focusing part (11), a main lens part (12) and between the pre-focusing part and the main lens part an intermediate electrode (23, G₃, G_{3B}) and a means for reducing ion cathode damage by ions (30) generated in or near the intermediate electrode. The electron gun (5) is provided with a means (41, 42, 51, 54) for generating inside the intermediate electrode (G₃, G_{3B}) an electrical field that comprises on a beam axis a component perpendicular to the beam axis. This leads the ions away from the electron beam and reduced the damage to the cathode in an efficient manner.

The invention relates to a display device comprising a cathode ray tube including an electron gun for generating at least one electron beam by means of a cathode, and a phosphor screen on an inner surface of a display window and a means for deflecting the electron beam(s) across the phosphor screen, the electron gun comprising a pre-focusing part, a main lens part and between the pre-focusing part and the main lens part an intermediate electrode and a means for reducing cathode damage by ions generated in or near the intermediate electrode.

Such a device is known from U.S. Pat. No. 4,075,533.

Electrons are generated by the cathode and are accelerated and focused in and by electrodes in the electron gun to form electron beams which are deflected by the deflection means and impinge on the screen to form an image. The electron gun comprises a pre-focusing part in which a pre-focus is made and a main lens part. In between the pre-focusing part and the main lens part an intermediate electrode (often called the focusing bus) is situated. As the electron beams traverse the electron gun ions are generated. These ions are attracted by the cathode and when the cathode is hit by said ions the cathode is poisoned by the ions and suffers sputter damage.

In the U.S. Pat. No. 4,075,533 it is proposed to provide for a means for reducing cathode damage by ions generated in or near the intermediate electrode by providing in front of the intermediate electrode an additional electrode at a voltage some 10 to 100 Volts higher than the voltage of the intermediate electrode. In this manner ions are repelled and do not hit the cathode which reduces the cathode damage by said ions.

Although application of such a means stops a large portion of the ions generated, it requires a relatively large voltage difference between the intermediate electrode and the additional electrode as well as the provision of an additional electrode.

It is an object of the invention to provide for a display device as described in the opening paragraph in which at least one of the above problems is reduced or eliminated.

To this end the device in accordance with the invention is characterised in that the electron gun is provided with a means for generating inside the intermediate electrode an electrical field that comprises on a beam axis a component perpendicular to the beam axis.

Such a transversal component will deflect the ions to one side of the beam axis, i.e. away from the electron beam. The electron beam, comprised of electrons at very high kinetic energy (typically in the order of thousands of electronVolts) is hardly effected by such a transversal component, however the generated ions, which are slow moving (having typically kinetic energies of in the order of 0.1 to 1 electronVolt) are pushed aside by such a transversal field component and are unable to reach the cathode or at least will be lead away from the most sensitive parts (the emitting parts) of the cathode. The inventors have realized and calculations below show that the trade-off between on the one hand adversal effects on the electron beam and on the other hand the efficiency of stopping the generated ions from reaching and impinging on the cathode or at least on the emitting parts of the cathode is better for a device in accordance with the invention than for the known device.

The invention can be embodied in several embodiments.

In one embodiment the intermediate electrode is provided with two sub-electrodes at both sides of the beam between which a voltage difference is applied in operation. The voltage difference creates a transversal field, pushing the generated ions out of the electron beam path and subsequently preventing them from impinging on the cathode.

In another, preferred embodiment the cathode facing side of the intermediate electrode is provided with an aperture to one side of an electron beam passing aperture. The extra aperture will generate an asymmetrical electric field inside the intermediate electrode (due to the Durchgriff through the extra aperture), which has for effect that the generated ions are attracted to the additional aperture, thus leading the ions away from the electron beam passing aperture and preventing the ions from impinging on the cathode. In these preferred embodiments no additional electrode is needed, nor the application of an additional voltage.

These and other objects of the invention will be apparent from and elucidated with reference to the embodiments described hereinafter.

In the drawings:

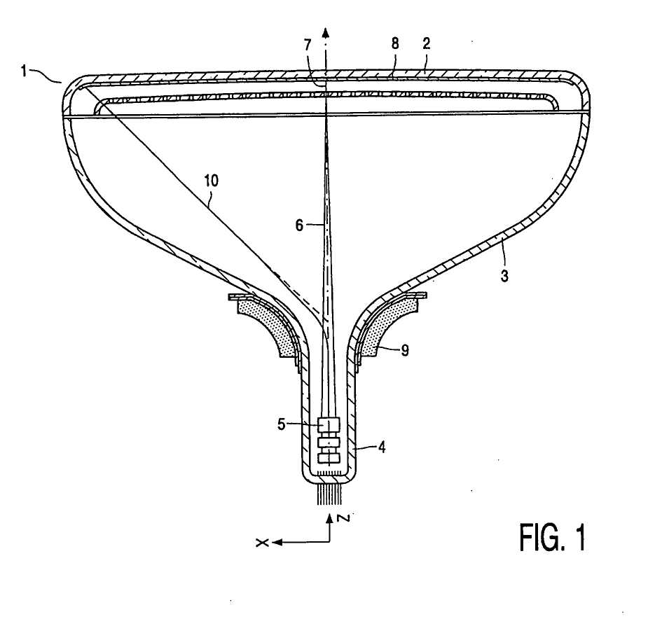

FIG. 1 is a sectional view of a display device;

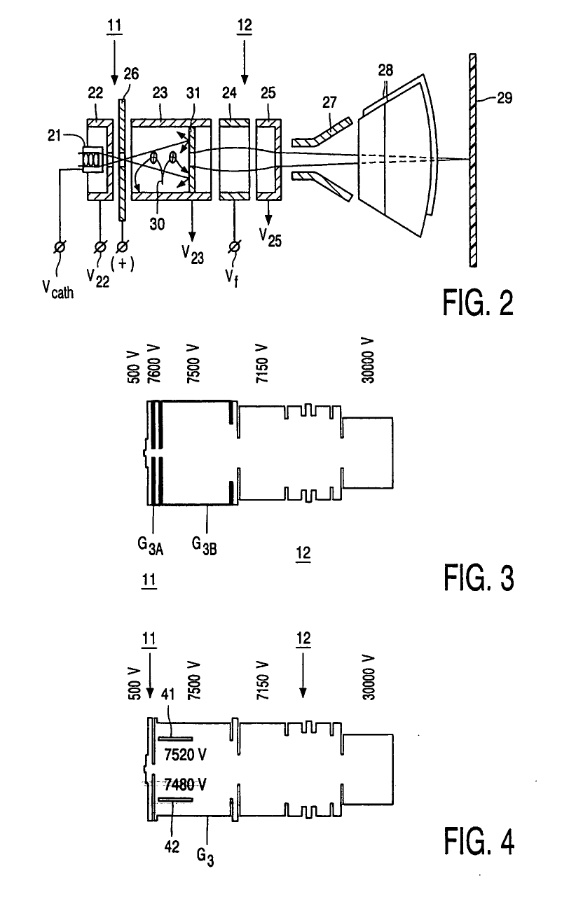

FIG. 2 shows in cross section an electron gun for a picture display device as known from U.S. Pat. No. 4,075,333.

FIG. 3 schematically shows details of an electron gun using the known design

FIG. 4 schematically shows details of an electron gun in accordance with an embodiment of the invention.

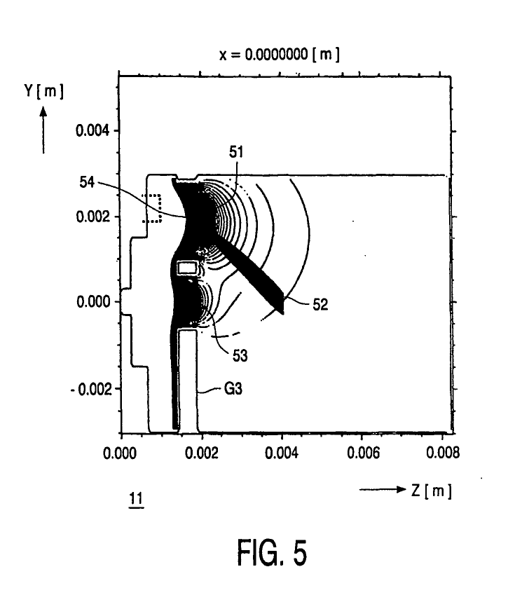

FIG. 5 schematically shows details of an electron gun in accordance with another embodiment of the invention.

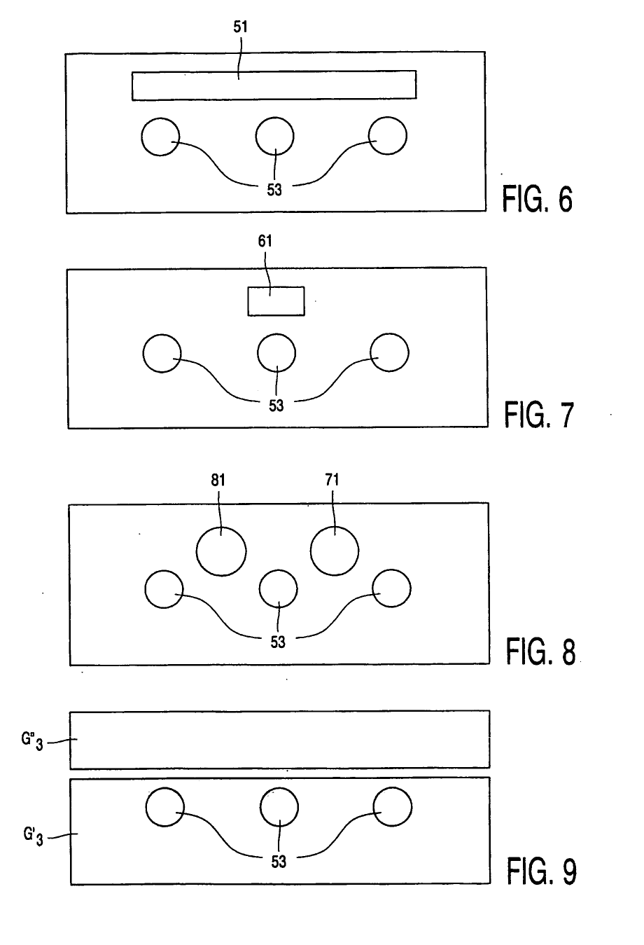

FIG. 6 shows a front view of an intermediate electrode (G₃) in accordance with an embodiment of the invention.

FIGS. 7, 8 and 9 show front views of further examples of an intermediate electrode in accordance with embodiments of the invention.

The Figures are not drawn to scale. In the Figures, like reference numerals generally refer to like parts.

The picture display device comprises a cathode ray tube 1, which includes a display screen 2, a cone portion 3, and a neck portion 4. In the neck portion 4, there is a means 5 for generating at least one electron beam 6. In the undeflected state, the electron beam 6 substantially coincides with the tube axis 7. The inner surface 8 of the display screen 2 comprises phosphor elements. When the undeflected electron beam 6 hits the phosphor, the latter becomes phosphorescent, thereby creating a visible spot on the display screen 2. On the way to the display screen 2, the electron beam 6 is deflected across the display screen 2 by means of a deflection system 9, thereby creating a two-dimensional picture.

The electrons in the electron beam can collide with molecules (or atoms) from the residual gas in the tube. These collisions cause ionisation of a part of the gas molecules. The generated ions are accelerated towards the cathode and usually focused onto a relatively small spot. In standard cathodes ion bombardment results in reduction of the electron emission, especially during the first few hours of operation when the residual gas pressure is high. Depending on the design of the electron gun the reduction of electron emission of a cathode due to ion bombardment can be unacceptably large. In that case a reduction of the intensity of the ion bombardment is required.

In the U.S. Pat. No. 4,075,533 it is proposed to provide for a means for preventing ions generated in or near the intermediate electrode from reaching the cathode by providing in front of the intermediate electrode an additional electrode at a voltage some 10 to 100 Volts higher than the voltage of the intermediate electrode. In this manner ions are repelled and do not hit the cathode.

FIG. 2 shows details of a display device as known from U.S. Pat. No. 4,075,533. The electron gun comprises a pre-focusing part, with a cathode 21 at a cathode voltage Vcath and a first grid 22 at a voltage V₂₂, an intermediate electrode 23 at a voltage V₂₃ and two main lens electrodes 24 and 25 at voltages V_{f} and V₂₅ In between the electrodes 22 and 23 an additional electrode 26 is positioned whose potential is some 10-100 Volt higher than V₂₃. After leaving the final electrode 25 the electron beam is deflected by deflection means (in this case electro-static deflection means) 27 and 28 to be scanned over a screen 29. In this manner positive ions 30 created by the electrons in the beam or by secondary electrons formed by impact of a part of the electrons on plate 31 containing an aperture are prevented from impinging on the cathode being repelled by electrode 26 and collected by electrode 23. It is remarked that the provision of the intermediate electrode basically provides for a substantially field-free space in between the pre-focus formed in and/or by the pre-focusing part 11 and the main focus formed in and/or by the main lens part 12. Either ends of intermediate electrode may to some extent play a part in forming the pre-focus and/or main lens.

Although in general such an arrangement performs reasonably well, i.e. a relatively large percentage of the ions is prevented from impinging on the cathode, the inventors have realized that the voltage difference required between the electrode 23 and the additional electrode 26 is rather high and an additional electrode 26 is required. It has surprisingly been found that using inside the electrode 23 an asymmetric electrical field, i.e. a field that comprises on the beam axis a component in a direction perpendicular to the longitudinal direction of the electron gun, i.e. perpendicular to the electron beam on the beam axis makes it possible to obtain with a smaller voltage difference a larger stopping effect, and in a most preferred embodiment a larger effect without even using an additional voltage difference or an additional electrode. The basic designs are exemplified in FIGS. 3 to 5, wherein FIG. 3 illustrates a device along the lines described in U.S. Pat. No. 4,075,533, in which the intermediate electrode G_{3B} is facing an additional electrode G_{3A} at a voltage 100 Volt higher than the voltage of G_{3B}, FIG. 4 illustrates a design in which by means of two sub-electrodes, in this example additional plates 41 and 42 inside intermediate electrode G₃, an asymmetrical electrical field is made by application of different voltages on plates 41 and 42, and FIG. 5 illustrates a design in which no additional electrode is present, nor a voltage difference is applied, but an asymmetrical field is generated by the presence of a hole 51 in intermediate electrode G₃. In FIG. 5 the equipotential lines are indicated. The trajectories 52 of ions generated directly behind the electron beam passing aperture 53 are also shown. These ions are drawn into the additional holes 51, and thus cannot reach the cathode. In the Figures the applied voltages are indicated. The extra aperture 51 generates an asymmetrical electric field inside the intermediate electrode (due to the Durchgriff through the extra aperture 51), which has for effect that the generated ions are attracted to the additional aperture 51 (see trajectories 52), thus leading the ions away from the electron beam passing aperture 53 in electrode G₃ and preventing the ions from impinging on the cathode. The important advantage of this embodiment is that no additional electrode needs to be provided nor an additional voltage difference needs to be applied. This greatly simplifies the design and eliminates some sources of error and misalignment, thus increasing the image quality. In the designs shown in FIGS. 3, 4 and 5 the intermediate electrode G_{3B} respectively G₃ is often also called the focusing electrode. In these exemplary embodiments the pre-focusing part is of the type described in International Patent Application WO 01/26131 A1. However, the type of pre-focusing part shown is shown as an example, and, although the invention is very useful for guns having this type of pre-focusing part, is not to be considered as a restriction on the scope of the invention in its broadest sense.

FIG. 6 shows a front view of the side of the G₃ electrode facing the cathode. In this example three in-line apertures 53 are provided with a single ion-deflecting aperture 51 to one side of the apertures.

Apart from the provision of the plates, or the hole 51 and the indicated voltages, everything else, i.e. all measures, such as distances between electrodes, electrode voltages, gas pressure, length of exposure, beam current and size and dimensions of apertures in electrodes are kept the same which enables a good comparison to be made of the positive effects on ion damage at the cathode, the voltage difference needed and the effects on induced beam errors.

TABLE 1
Comparison between percentage remaining damage
(calculated damage is sputter damage at centre of cathode),
required voltage difference ΔV, and increase of 5% and
30% x-respect. y-LSF (Line Spread Function) value.

| | | % remaining | | |
|---|---|---|---|---|
| Design | ΔV | damage | % increase | Remark |
| | 100 | 40% | Less than 6% | |
| | 40 | 30% | Less than 6% | |
| | None | 35% | Less than 5% | No additional |
| | | | | voltage or |
| | | | | electrode needed |

Comparing the results as given in Table 1, it is clear that with respect to the known design (FIG. 3) using an asymmetric electrical field, i.e. a field that has on the axis of the electron beam an electrical field perpendicular to the beam axis, leads to better results. The device as shown in FIG. 4 uses a voltage difference of only 40% of the voltage difference in the device as shown in FIG. 3, and the induced error is comparable yet the ion damage is 25% less in the device shown in FIG. 4 than in the device shown in FIG. 3. Likewise, when comparing the data for the device as shown in FIG. 5 to the data for the device as shown in FIG. 3, it becomes clear that the damage is reduced by 12.5% (instead of 40%, 35% remaining) and the induced error is reduced by roughly 16% and all that without the need for an additional voltage or electrode. It is remarked that part of the damage is done by ions generated in the beam in the pre-focusing part. Consequently there is a bias percentage damage (roughly 20%) which cannot be influenced by means in or near the focusing electrode. Even if the stopping effects of the means would be 100% a bias damage remains. If this bias damage is taken into consideration the positive effects of the invention stand out even more clearly. A reduction of 40% remaining damage to 30% remaining damage (comparison between FIGS. 3 and 4) actually means that the stopping effect is twice as effective.

An asymmetrical field, i.e. a field which on the beam axis comprises a component perpendicular to the beam axis, is thus more effective in stopping the ions than a symmetrical stopping field, i.e. a field that is symmetric with respect to the beam axis. It is also noted that the invention has a further advantage. In order for a symmetrical field to be effective there has to be a region on the axis inside the electrode G3 for which the electrical field is actually reversed in direction along the axis, i.e. there has to be a potential maximum. Such a potential maximum acts as a barrier to the ions. However, simply using an electrode at a higher potential does not necessarily work, the potential differences have to be rather high. Smaller differences in voltages do not create a barrier and subsequently will not or much less have effect. Therefore there is a cut-off voltage difference below which the positive effects do not or much less occur. This, however, also means that, given the fact that inevitably in any manufacturing process spread occurs in measures, such as distances between electrodes and sizes of apertures in electrodes and applied voltages, there will be a large spread in the positive effect, unless the applied voltage difference is so high that the stopping effects always occur. To put it simply, in order to be sure that the positive effect is obtained, a higher than nominally necessary voltage difference needs to be applied. In contrast to this the positive effects in the design in accordance with the invention as shown in FIG. 4 are much more linear with applied voltage difference so that slight deviations from the ideal situation have much less influence and a more moderate voltage can be chosen.

It will be clear that within the framework of the invention many variations are possible. For instance an asymmetrical electrical field may be obtained by splitting the electrode in two, an upper part (G′₃), and a lower part (G″₃) wherein the electron beam passing apertures may be formed in between the two parts, or in one of the parts, in which case the part with the apertures will in general be larger than the other part and a small (20-60 Volt) voltage difference is applied between the two halves (see FIG. 9). FIGS. 7 and 8 show two front views of focusing electrodes G₃. In FIG. 7 one single aperture 61 above the central of the beam passing apertures 53 is provided. In some devices the main problem lies in the central electron beam. If such is the case a single relatively small aperture 61 will be sufficient. FIG. 8 shows two apertures 71 and 81 half-way in between the middle and the outer apertures 53.

In a preferred exemplary embodiment the electrode facing the G₃ electrode is opposite to the aperture 51 provided with a shoulder or protuberance 54 (FIG. 5, indicated by dotted lines). This increases the Durchgriff through the aperture 51, thus increasing the pulling effect on the generated ions.

In short the invention can be described as:

A display device comprises a cathode ray tube (1) with an electron gun (5) for generating at least one electron beam (6) by means of a cathode, a phosphor screen (8) on an inner surface of a display window (2) and a means (9, 27, 28) for deflecting the electron beam(s) across the phosphor screen. The electron gun comprising a pre-focusing part (11), a main lens part (12) and between the pre-focusing part and the main lens part an intermediate electrode (23, G₃, G_{3B}) and a means for reducing ion cathode damage by ions (30) generated in or near the intermediate electrode. The electron gun (5) is provided with a means (41, 42, 51, 54) for generating inside the intermediate electrode (G₃, G_{3B}) an electrical field that comprises on a beam axis a component perpendicular to the beam axis. This leads the ions away from the electron beam and reduced the damage to the cathode in an efficient manner.

1. Display device comprising a cathode ray tube (1) including an electron gun (5) for generating at least one electron beam (6) by means of a cathode, and a phosphor screen (8) on an inner surface of a display window (2) and a means (9, 27, 28) for deflecting the electron beam(s) across the phosphor screen, the electron gun comprising a pre-focusing part (11), a main lens part (12) and between the pre-focusing part and the main lens part an intermediate electrode (23, G₃, G_{3B}) and a means for reducing ion cathode damage by ions (30) generated in or near the intermediate electrode, characterised in that the electron gun (5) is provided with a means (41, 42, 51, 54) for generating inside the intermediate electrode (G₃, G_{3B}) an electrical field that comprises on a beam axis a component perpendicular to the beam axis.

2. Display device as claimed in claim 1, characterised in that the means for generating comprises two sub-electrodes (41, 42) each at one side of the electron beam path between which sub-electrodes a voltage difference is applicable.

3. Display device as claimed in claim 1, characterised in that the cathode facing side of the intermediate electrode (G₃) is provided with an aperture (51) to one side of an electron beam passing aperture (53).

4. Display device as claimed in claim 3 characterised in that the electron gun is of the in-line type, the intermediate electrode (G₃) comprising three electron beam passing apertures situated on a line for passing three electron beams, and in that a single aperture (51) spans all three beam passing apertures (53).

5. Display device as claimed in claim 3 characterised in that the electron gun is of the in-line type, the intermediate electrode (G₃) comprising three electron beam passing apertures situated on a line for passing three electron beams, and in that a single aperture (61) is positioned near a central of the three beam passing apertures (53).

6. Display device as claimed in claim 3 characterised in that the electron gun is of the in-line type, the intermediate electrode (G₃) comprising three electron beam passing apertures situated on a line for passing three electron beams, and in that two apertures (71, 81) are provided each of which is positioned above or below and in between a central and an outer of the three beam passing apertures (53).

7. Display device as claimed in claim 3, characterised in that an electrode facing the cathode facing side of the intermediate electrode (G₃) is provided with a shoulder or protuberance (54) extending towards the cathode facing side of the intermediate electrode.

8. Display device as claimed in claim 1, characterised in that the intermediate electrode comprises two or more parts (G′₃, G″₃), which parts in function are provided with separate potentials.
